(19) United States
(12) Patent Application Publication
(10) Pub. No.: US 2015/0353228 A1
(43) Pub. Date: Dec. 10, 2015

(54) Can/flass soda can. The new can opening.

(71) Applicants: Adam Herriott, Hermosa Beach, CA (US); Alicja Herriott, Hermosa Beach, CA (US)

(72) Inventors: Adam Herriott, Hermosa Beach, CA (US); Alicja Herriott, Hermosa Beach, CA (US)

(21) Appl. No.: 13/987,294

(22) Filed: Jun. 10, 2013

(51) Int. Cl. B65D 17/00; G07F 9/10; B65D 1/12

(52) U.S. Cl. CPC B65D 17/163; B65D 1/12; G07F 9/105

(57) ABSTRACT

The two presented opening in “the glass of soda in the can” remove the whole top of the can. and still keep the original design of a small opening. The new opener is able to keep enough pressure and to open a whole top of can without braking. The second opener is design to pull the string from the top, which consequently removes a whole top of a can. Both types of the new can open ends with the same result. The practical aspect of usage of the new soda can: it makes possible to add ice to a drink, it enable to keep it cold by adding an ice, the can be reused, limits the necessity of refrigeration, for advertising purpose by placing adds inside of the can. The new opening brings the higher taste of the drink by not loosing carbohydrates from the soda; which occurs by pouring the carbohydrates. “The glass of soda in the can. The new opening” improves a quality of the drink, saves energy, allows reusing the product and has no any additional cost to the production.

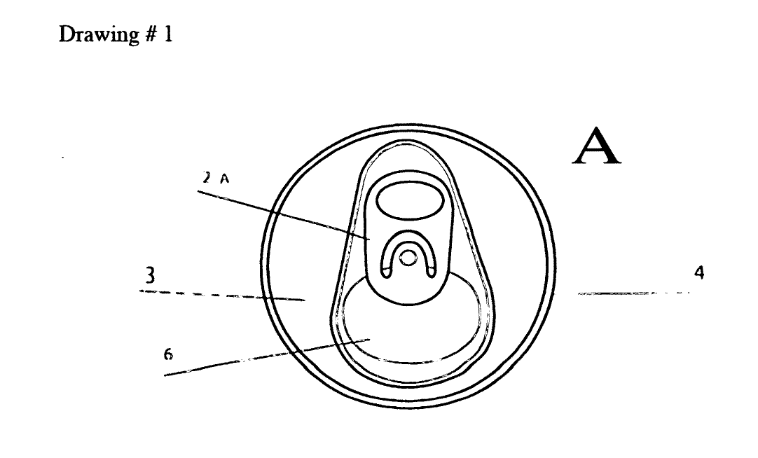

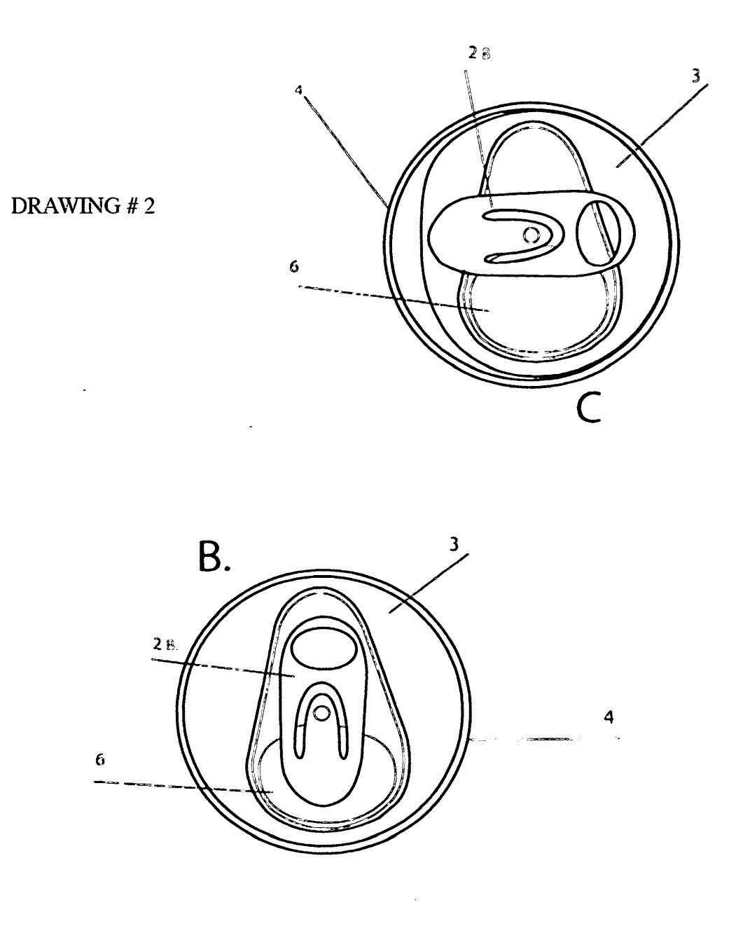

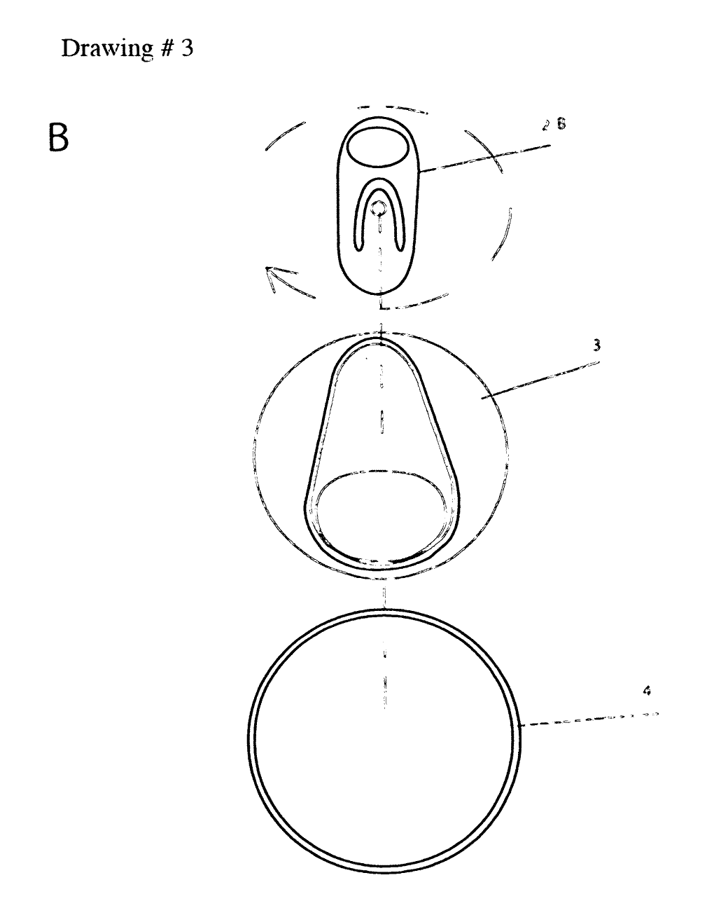

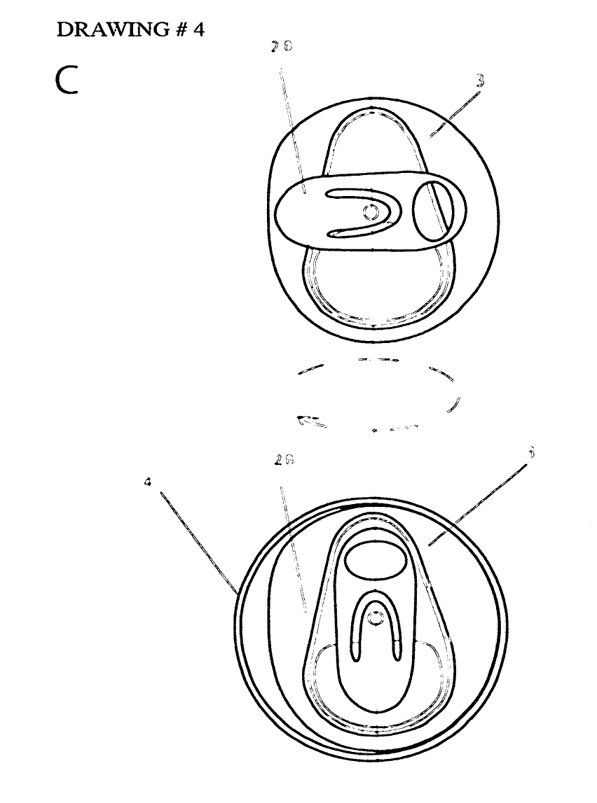

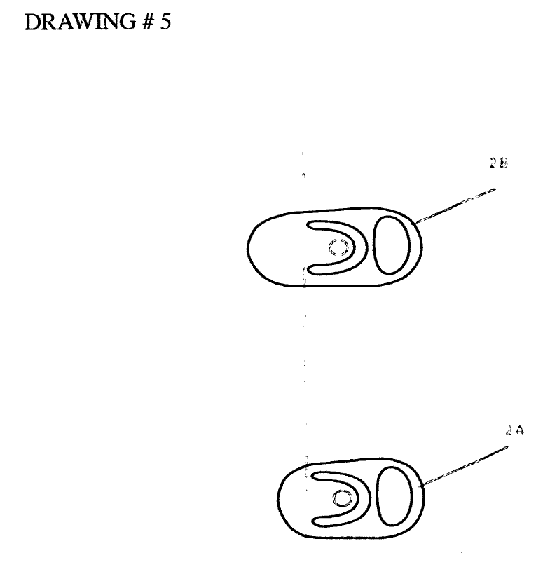

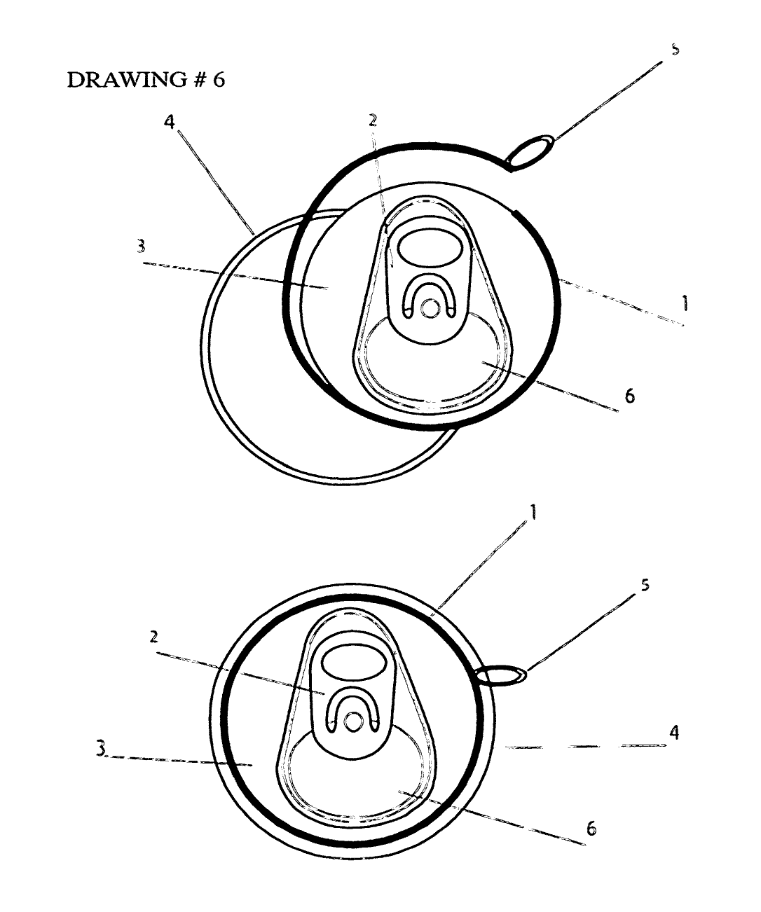

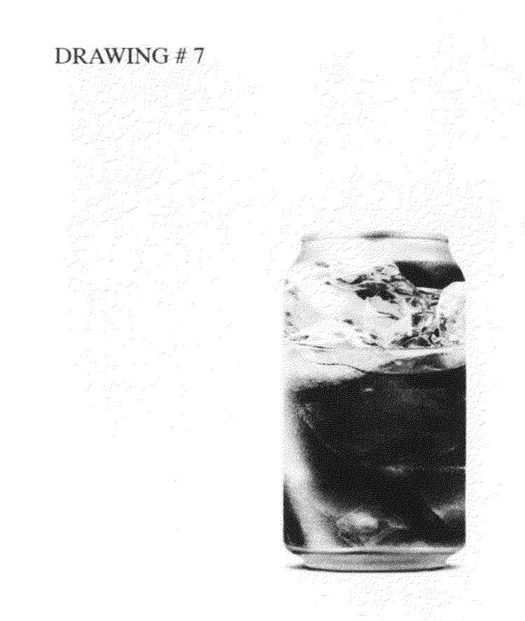

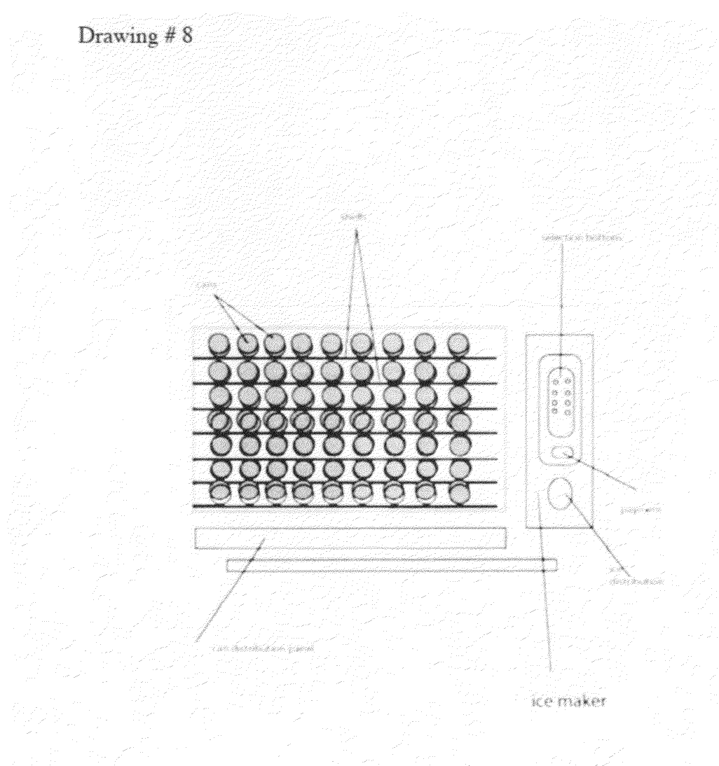

The invention is an improvement of existing product of soda can. The improvement brings additional option of a can opening. Reference to Drawing #1. Original product has only one small opening placed on top of the can. Reference to Drawing #1. The new top of the can will have two openings: the original, small one and the additional larger wide opening. Reference to Drawing #4.

The whole top of the can is pre separated from the edge and side of the can in the way a small hole is pre separated from the rest of the surface of the top. Reference to Drawing #2 & 4. The technique of removing the whole top of can is the same as a technique of removing small whole top surface from the rest of the surface area, as it is in original top of the can. One of ç. Reference to Drawing #3. This can opener has to be twisted to the side position away from the space reserved for a small whole opening. This position of the tip of the can opener is far enough from a small opening to be able open the desired wide opening only. Reference to drawings#3 & 4.

The can opener is applying enough pressure on the top surface to separate the whole top from the sides of the can.

The new “top opener” has the same shape and design, as it is the original. Reference to Drawing #5. The new “top opener” is made from the same material, which would allow to application of enough pressure without breaking it. The new can opener is slightly larger/longer, so it is able to press on the large hole on the can top and also on the small whole opening. Reference to Drawings #5.

This new constructed can opener is the same shape as it is on original one, but it has a necessary length extension to reach a larger surface of the top. The new top opener might need to be made with a stronger material to be able apply a pressure on it without breaking “the top opener”.

The separation of the whole top from the rest of the can is made in the same technical way as it is in a separation of the original small opening from the rest of the surface of the can.

The second way to open of the top of can is pulling the string cut out in the top of the can located by the edge of the can. The string has the ending, a loop, to hold, and it is use to pull out all string out from top of can. Reference to Drawings #6. The string on the top the can is pre separated from the side of the top and side of the can.

After a top of can is removed, the ice cubs can be dropped into the soda. The ice will cool the drink down. The costumer does not have to keep the soda can in refrigerator to serve a cold drink, and it allows him or her to add ice in to the drink any time without diluting in it by excess of ice, or loosing carbonizes and quality of soda by pouring it in to the cup.

The new can has a new visual design reflecting the invention of the can/glass way drinking soda. The image supports and encourages a new experience of drinking soda from a can as it is drinking it from a glass. Reference to drawing #7. The designer is providing a possible but not limited to a design of can/glass soda vent machine. Reference to Drawings #8. The new vent machine, depends of the need, has a space for unlimited amount of cans in it, and has a only a small ice machine on the side selling a portion of ice cubs, which are paid for by costumer first. The porches of ice cubes can be done without buying soda also. The possibility of buying ice cubs only gives a costumer a possibility to add more ice if necessary to keep it cool.

The patent has advanced features—(does your invention offer significant improvements?) It gives a costumer second choice of a new way drinking soda from the can. It is enable to cool the drink down, without refrigeration, any time before and during drinking the soda

The invention will have Demands—(an existing demand for the invention) Not yet, but just like Steve Jobs said, “People don't know what they want until you show it to them.” And I think once we introduce my invention to the world there will be a large demand, so much so that there will be no need for the old fashioned cans. The need of convenience, comfort and the importune of giving options to the drinker will create a demand. For the costumer: the convenient of storage of larger amount of cans without refrigeration and have them cold at the moment of serving gives a costumer a great comfort of not to worry to keep the drinks cold, to have coolers, plastic cups to serve a cold drink. There is no need for coolers for storage of the can soda, or paper/plastic cups for serving. The convenience of buying cases of soda and just a bag of ice to serve cold drinks is unrespectable. For example, the glass/can would be perfect for outdoor parties. Costumer can grab cases of soda and a bag of ice and can serve an unlimited amount of cold drinks all a time. The invention saves money and time. There is no need for refrigeration in the super markets or in any kind of stores. The invention saves a space and electricity to keep all the soft drinks cold. A good icemaker is enough to satisfy a costumer who wants to buy a cold drink. He or she grabs a can of soda, opens it, drops desire amount of ice cubs in to it and not worry about the drink get cold too soon, as it happens with drinks from the refrigerator. For business: No refrigeration needed to keep the drinks cold. It saves on energy and store space can be use for other products. The cans with wide opening are reusable. The empty are reusable.

The invention has great Distribution Capabilities—(it is easy not difficult to distribute and sell my invention). The distribution stays the same or even increases a need for the product. The new design of can/glass will brings people attention to the product, so when they see it in stores or in commercials, naturally they will be driven to the newest hit. No refrigeration is needed for the product, no need for portable cups; it's a two in one product, having the comfort of a portable can with the luxury of ice. It allows costumer to store more products since there is no need to have plastic cups taking up space. A new vending machine can also be introduced will have large space for storage and ice machine to buy the ice. A new vending machine will can storage more product and save on electricity.

The invention has a future and a long Life a head. (My invention will last longer than other products) My invention will over rule the older/original version of the can opener. It also gives the buyer the ability to recycle them as ordinary cups a few times until the can wears out, but it will be as durable as the previous design.

My invention has a wide Market—(a existing market for my invention, and the size of the market). As to this moment a market for the soda is big. The need for the new designed can is going to be a lot bigger due to its convenient and attractive design and use of the can. The size of the market is going to be bigger than previous market; the can/glass just has a better design.

The invention has no market barriers (difficulties to enter a market) the market for soda can already exist, but new can will extend market for a new can and a new way drinking from it. I would be very easy to extend the market by incorporating in to it the new design of the can.

The Performance of the invention—(the invention perform better than other products (including better, faster output, less noise, better smell, taste, look or feel)? My invention creates a better product then the original one. It dives a costumer a new experience of drinking soda, a better taste, more carbonation in it, cold to the last drop of the liquid in the can, possibility of reusing the can for drinking or any other purpose.

My invention will give the drinker the option of using the old fashioned little opening on the can which doesn't allow you to do much besides drinking straight from it or pouring the liquid into another cup or they'll have the option to peal the entire lid off.

My invention will take just as long to get the lid entirely off as it would to just open the smaller. opening. It's faster having the option to peel back the entire lid of the can cuts out the time and effort of having to pour the drink into another cup with ice, if the drinker desires ice.

Better feel. The wide top option gives a longer cold feel, just as if you pulled an ice cold beverage from the refrigerator, the ice in the can gives a prolonged ice cold sensation on the drinkers hand as if it was a glass, giving him a consistent cool drink that never has to see the inside of a refrigerator.

A new and improved look. The new design of the can will be exciting, by linking the can and the glass together. There's nothing that gives a better refreshing feeling then seeing ice sticking out from the top of a cup of soda. A something we are not getting from an exciting can design. Along with the wide top opening, the new cover design shown earlier completes the all-around look and idea that is portrayed of the glass can.

The large opening allows a customer to use a small amount of ice to cool down the soda without having to purchase an additional portable plastic/paper cup.

Improved Taste. The motivation behind any beverage is obviously the taste, but there is nothing that allows you to place ice into your drink without having to pour your drink into another cup. And for tastes sake, pouring does not help. In the process of pouring, we all know that a major percent of the carbonation in our carbonated drinks is lost. It doesn't matter if you're pouring it from: a glass bottle, a can, or a 2-liter bottle or from tap, carbonation is lost. The glass/can will be the first beverage you can open and immediately place ice without having to pour which preserves the taste, increasing the flavor and the all-around a better experience of drinking a beverage from a can. Drinking from a glass improves the taste of our drink because our tastes buds are connected to our noses, so being able to sniff the aroma of our beverage increases the taste on our tongues, just as if the drinker was drinking from a glass. Everyone knows the bad flavor of flat warm soda at the end of the can.

My invention is simply better and the glass/can creates convenience for the drinker. It also creates faster preparation, with luxury of ice with the portability of a plastic/paper cup. My invention gives the drinker a more personalized beverage that you couldn't get from just the small opening of a can.

The invention Production Capabilities—(it is easy to produce my invention) No sufficient changes to the production of the original top of the can. The extension of the “can opener” should not be difficult at all. There is no sufficient changes or increasing difficulties of the production.

The invention Production Costs—can you obtain accurate manufacturing costs (both per unit and setup/tooling)? It will keep the same amount of cost as the production of existing can. The new extended the can opener should not bring more cost to the production of it.

The invention Regulations and Laws (the invention specific regulatory requirements or are there special laws that must be followed (i.e.: FDA approval) No changes to the material the can, so existing laws should to stay.

The invention Retail Price—(a price advantage or disadvantage) The cost of production is not going to be higher, so a price of the product can to stay the same or it should be increased for more profit. Definitely, the product is going to be very popular, so businesses should to take an advantage of it and increase a price a little.

1. I claim the idea of removing the entire top of a can to make a wider opening in the can and in any other container with wide opening designed to hold the liquid in it.

2. In relation to claim #1, I claim, but not limited to, the wide top opening in the can of any size and placement.

3. In relation to claim #1, I claim, but not limited to of a technical removal of the top of the can described in “Description”, in reference to Drawings #4, #6, movie clips: Opening 2, Opening 1.

4. In relation to claim #1, I claim, but not limited to, the new way constructed can with ability to place ice cubs into.

5. I claim a design on the can resembling the picture of a soda and ice in the glass with all the elements of the design: ice, liquid/soda, colors as it is in reference of the image of the design Drawing #7A, on Page 8, CD, movie clip “new design.”

6. I claim a design of a new vent machine but not limited to regular, standard shelf storage with ice cubs machine attached in to it. In Reference in to design Drawing #8,
